(19) United States
(12) Patent Application Publication
(10) Pub. No.: US 2018/0327321 A1
(43) Pub. Date: Nov. 15, 2018

(54) Zr-BASED COMPOSITE CERAMIC MATERIAL, PREPARATION METHOD THEREOF, AND SHELL OR DECORATION

(71) Applicant: BYD COMPANY LIMITED, Shenzhen (CN)

(72) Inventors: Qing GONG, Shenzhen (CN); Xinping LIN, Shenzhen (CN); Ge CHEN, Shenzhen (CN); Bo WU, Shenzhen (CN)

(73) Assignee: BYD COMPANY LIMITED, Shenzhen (CN)

(21) Appl. No.: 15/775,528

(22) PCT Filed: Nov. 23, 2016
(86) PCT No.: PCT/CN2016/106863

§ 371 Date: May 11, 2018

(30) Foreign Application Priority Data
Nov. 30, 2015 (CN) 201510863961.X

(51) Int. Cl. C04B 35/48; C04B 35/626; C04B 35/64; C04B 35/634

(52) U.S. Cl. CPC C04B 35/48; C04B 35/62655; C04B 35/64; C04B 35/6261; C04B 35/63416; C04B 2235/3246; C04B 2235/9661; C04B 2235/447; C04B 2235/3222; C04B 2235/602; C04B 2235/6567; C04B 2235/85; C04B 2235/3255

(57) ABSTRACT

A Zr-based composite ceramic material, a preparation method thereof, and a shell or decoration are provided. The Zr-based composite ceramic material includes a zirconia matrix, a cubic Sr_{0.82}NbO₃ stable phase, a Ca₁₀(PO₄)₆(OH)₂ phase, and a SrAl₁₂O₁₉ phase, and the cubic Sr_{0.82}NbO₃ stable phase, the Ca₁₀(PO₄)₆(OH)₂ phase and the SrAl₁₂O₁₉ phase are dispersed within the zirconia matrix.

### CROSS-REFERENCE TO RELATED APPLICATION

This application claims priority to and benefits of Chinese Patent Application Serial No. 201510863961.X, filed with the State Intellectual Property Office (SIPO) of P. R. China on Nov. 30, 2015. The entire contents of the above mentioned application is incorporated herein by reference.

### FIELD

The present disclosure generally relates to a ceramic material and its application field, and especially relates to a Zr-based composite ceramic material, a preparation method thereof, and a shell or a decoration.

### BACKGROUND

With highly development of science and technology, requirement for performance and quality of a ceramic material becomes higher and higher. A zirconia ceramic has a wide application due to their relatively better corrosion resistance, higher hardness and higher strength as compared to other ceramic. However, when manufactured to be an appearance parts having a large area, the current zirconia ceramic still has a poor drop resistance performance even though it has a relatively high tenacity (which may reach 5-6 MPa·m^{1/2}) as compared to other ceramic. Thus, there is still a need to improve the drop resistance performance of the zirconia ceramic when the zirconia ceramic is used to manufacture the appearance part.

### SUMMARY

The present disclosure seeks to solve at least one of the technical problems in the related art to some extent. Therefore, the present disclosure provides a Zr-based composite ceramic material having a good drop resistance performance, a preparation method thereof, and a shell or a decoration.

According to a first aspect of the present disclosure, a Zr-based composite ceramic material is provided, the Zr-based composite ceramic material includes: a zirconia matrix, a cubic Sr_{0.82}NbO₃ stable phase, a Ca₁₀(PO₄)₆(OH)₂ phase, and a SrAl₁₂O₁₉ phase, and the cubic Sr_{0.82}NbO₃ stable phase, the Ca₁₀(PO₄)₆(OH)₂ phase and the SrAl₁₂O₁₉ phase are dispersed within the zirconia matrix.

According to a second aspect of the present disclosure, a method for preparing a Zr-based composite ceramic material is provided. The method includes: preparing a mixed slurry by mixing a zirconia powder, a Ca₁₀(PO₄)₆(OH)₂ powder, a SrAl₁₂O₁₉ powder, a SrCO₃ powder, a Nb₂O₅ powder and a binder; and obtaining the Zr-based composite ceramic material by drying, molding and sintering the mixed slurry in sequence; in which a molar ratio of the SrCO₃ powder to the Nb₂O₅ powder is 1.64:1.

According to a third aspect of the present disclosure, a Zr-based composite ceramic material prepared by the method mentioned above is provided.

According to a fourth aspect of the present disclosure, a shell or a decoration is provided. The shell or the decoration is made of any one of the Zr-based composite ceramic materials mentioned above.

With the Zr-based composite ceramic material of the present disclosure, a tenacity and a drop resistance performance thereof may be effectively improved by dispersing the cubic Sr_{0.82}NbO₃ stable phase, the Ca₁₀(PO₄)₆(OH)₂ phase and the SrAl₁₂O₁₉ phase within the zirconia matrix, thus making it suitable to be used to manufacture an appearance part having a large area, such as a shell or a decoration.

Additional aspects and advantages of embodiments of present disclosure will be illustrated in detail in the following descriptions.

### BRIEF DESCRIPTION OF THE DRAWINGS

The accompanying drawings, which constitute a part of this specification, serve to further illustrate and explain the principles of the invention together with the following embodiments, and shall not be construed to limit the present disclosure, in which:

FIG. 1 is a diagram showing an XRD diffraction pattern of P1 prepared in Testifying Example 1 and standard cards of SrNb₆O₁₆ (00-045-0228) and Sr₂Nb₂O₇ (01-070-0114); and

FIG. 2 is a diagram showing an XRD diffraction pattern of P2 prepared in Testifying Example 2 and standard cards of tetragonal phase zirconia (00-017-0923), monoclinic phase zirconia (01-083-0939) and Sr_{0.82}NbO₃ (00-009-0079).

### DETAILED DESCRIPTION

Embodiments of the present disclosure are described in detail below, and examples of the embodiments are shown in accompanying drawings. The following embodiments described by referring to the accompanying drawings are illustrative, aim at explaining the present disclosure, and should not be interpreted as limitations to the present disclosure.

As mentioned in the BACKGROUND, there is a need to further improve the drop resistance performance of the current zirconia ceramic. To this end, inventors of the present disclosure have done intensive researches on the zirconia ceramic, and provide a Zr-based composite ceramic material. The Zr-based composite ceramic material includes a zirconia matrix, a cubic Sr_{0.82}NbO₃ stable phase, a Ca₁₀(PO₄)₆(OH)₂ phase, and a SrAl₁₂O₁₉ phase, in which the cubic Sr_{0.82}NbO₃ stable phase, the Ca₁₀(PO₄)₆(OH)₂ phase and the SrAl₁₂O₁₉ phase are dispersed within the zirconia matrix (inside or on a surface thereof).

With the Zr-based composite ceramic material of the present disclosure, a tenacity and a drop resistance performance thereof may be effectively improved by dispersing the cubic Sr_{0.82}NbO₃ stable phase, the Ca₁₀(PO₄)₆(OH)₂ phase and the SrAl₁₂O₁₉ phase within the zirconia matrix (inside or on a surface thereof), thus making it suitable to be used to manufacture an appearance part having a large area, such as a shell or a decoration.

It should be noted that there is no particular limitation for the content of the cubic Sr_{0.82}NbO₃ stable phase, the Ca₁₀(PO₄)₆(OH)₂ phase and the SrAl₁₂O₁₉ phase, the tenacity of the Zr-based composite ceramic material may be regulated to some extent as long as the zirconia matrix includes the cubic Sr_{0.82}NbO₃ stable phase, the Ca₁₀(PO₄)₆(OH)₂ phase and the SrAl₁₂O₁₉ phase. It should also be noted that contents of the cubic Sr_{0.82}NbO₃ stable phase, the Ca₁₀(PO₄)₆(OH)₂ phase and the SrAl₁₂O₁₉ phase may be regulated by those skilled in the art according to a common content of auxiliary material used for regulating the tenacity of ceramic material in the art.

In some embodiments, the Zr-based composite ceramic material includes about 0.2 mol % to about 8 mol % of the cubic Sr_{0.82}NbO₃ stable phase, about 0.05 mol % to about 1 mol % of the Ca₁₀(PO₄)₆(OH)₂ phase, and about 0.13 mol % to about 0.83 mol % of the SrAl₁₂O₁₉ phase, based on 100 mol % of zirconia matrix. The Zr-based composite ceramic material of the present disclosure may have milk white color and enhanced tenacity and drop resistance performance with the contents of the cubic SrₓNbO₃ stable phase, the Ca₁₀(PO₄)₆(OH)₂ phase and the SrAl₁₂O₁₉ phase within above ranges.

In some embodiments, the Zr-based composite ceramic material includes about 1 mol % to about 6.1 mol % of the cubic Sr_{0.82}NbO₃ stable phase, about 0.1 mol % to about 0.7 mol % of the Ca₁₀(PO₄)₆(OH)₂ phase, and about 0.17 mol % to about 0.75 mol % of the SrAl₁₂O₁₉ phase, based on 100 mol % of the zirconia matrix. Then tenacity and chroma of the Zr-based composite ceramic material may be further improved.

During preparation of the Zr-based composite ceramic material mentioned above of the present disclosure, raw materials include: zirconia powder, Ca₁₀(PO₄)₆(OH)₂ powder, SrAl₁₂O₁₉ powder, SrCO₃ powder, and Nb₂O₅ powder. In some embodiments, the zirconia powder is a tetragonal phase zirconia powder stabilized with 3 mol % of yttrium. By adding the Ca₁₀(PO₄)₆(OH)₂ powder, the Ca₁₀(PO₄)₆(OH)₂ phase may be formed in the Zr-based composite ceramic material. By adding the SrAl₁₂O₁₉ powder, the SrAl₁₂O₁₉ phase may be formed in the Zr-based composite ceramic material. The SrCO₃ powder and the Nb₂O₅ powder included in the raw materials may form the cubic Sr_{0.82}NbO₃ stable phase within the zirconia matrix after being sintered. The Zr-based composite ceramic material may have a milk white color due to the formation of the Ca₁₀(PO₄)₆(OH)₂ phase, the SrAl₁₂O₁₉ phase and the cubic Sr_{0.82}NbO₃ stable phase.

In the Zr-based composite ceramic material mentioned above of the present disclosure, it is presumed that the SrCO₃ (strontium carbonate) powder and the Nb₂O₅ (niobium pentoxide) powder may achieve a complete reaction to generate the cubic Sr_{0.82}NbO₃ stable phase, therefore, the content of the cubic Sr_{0.82}NbO₃ stable phase in embodiments of the present disclosure is determined by a feed ratio of the SrCO₃ (strontium carbonate) powder to the Nb₂O₅ (niobium pentoxide) powder.

It should be noted that there is no particular limitation for particle sizes of the zirconia powder, the Ca₁₀(PO₄)₆(OH)₂ powder, the SrAl₁₂O₁₉ powder, the SrCO₃ powder, and the Nb₂O₅ powder, and reference can be made to a conventional selection for particle sizes of raw materials for preparing a Zr-based composite ceramic material in the art. For example, a particle size D50 of the zirconia powder may be about 0.1 microns to about 1 micron, such as about 0.5 microns to about 0.8 microns, a particle size D50 of the Ca₁₀(PO₄)₆(OH)₂ powder may be about 0.1 microns to about 2 microns, such as about 0.2 microns to about 0.7 microns, a particle size D50 of the SrAl₁₂O₁₉ powder may be about 0.1 microns to about 2 microns, such as about 0.2 microns to about 0.7 microns, and particle sizes D50 of both the SrCO₃ powder and the Nb₂O₅ powder may be about 0.2 microns to about 5 microns. It should be noted that the particle size D50 means a volume average diameter, which may be determined by a particle size measurement with a laser particle analyzer after dispersing the powder to be tested in water, and ultrasonic shaking for about 30 minutes.

It should be noted that, as long as the cubic Sr_{0.82}NbO₃ stable phase, the Ca₁₀(PO₄)₆(OH)₂ phase and the SrAl₁₂O₁₉ phase are contained within the Zr-based composite ceramic material, the Zr-based composite ceramic material may have a certain color. In some embodiments, the Zr-based composite ceramic material has a CIELab color value L of about 89 to about 92, a CIELab color value a of about 0.01 to about 0.5, and a CIELab color value b of about 0.01 to about 0.5. L, a and b are chromaticity coordinates in a CIELab color space. Then a chroma of the Zr-based composite ceramic material may be further improved, and the Zr-based composite ceramic material may have a milk white color and achieve a shining effect.

The Zr-based composite ceramic material mentioned above of the present disclosure may be manufactured by mixing the zirconia powder, the Ca₁₀(PO₄)₆(OH)₂ powder, the SrAl₁₂O₁₉ powder, and the cubic Sr_{0.82}NbO₃ stable phase powder to form a mixture, and drying, molding and sintering the mixture. The manufacturing method of the Zr-based composite ceramic material mentioned above of the present disclosure may be any common method in the art, as long as the Zr-based composite ceramic material obtained includes the Ca₁₀(PO₄)₆(OH)₂ phase, the SrAl₁₂O₁₉ phase and the cubic Sr_{0.82}NbO₃ stable phase.

It should be noted that, generally, a powder of the current cubic Sr_{0.82}NbO₃ stable phase has a relatively high price, which may be not good for wide application of the Zr-based composite ceramic material. Therefore, in the present disclosure, the SrCO₃ powder and the Nb₂O₅ powder both having a relatively low price are adopted at a certain ratio to form the desired cubic Sr_{0.82}NbO₃ stable phase within the zirconia powder after being sintered.

The present disclosure further provides a method for preparing a Zr-based composite ceramic material. The method includes: preparing a mixed slurry by mixing a zirconia powder, a Ca₁₀(PO₄)₆(OH)₂ powder, a SrAl₁₂O₁₉ powder, a SrCO₃ powder, a Nb₂O₅ powder and a binder; and obtaining the Zr-based composite ceramic material by drying, molding and sintering the mixed slurry in sequence; in which a molar ratio of the SrCO₃ powder to the Nb₂O₅ powder is 1.64:1.

With this method, by adding SrCO₃ powder and Nb₂O₅ powder (both of which have a function similar to a sintering aids), a sintering temperature for preparing the Zr-based composite ceramic material may be relatively reduced under the same condition, such that the Zr-based composite ceramic material obtained may have a more compact structure. In addition, a cubic Sr_{0.82}NbO₃ stable phase may be obtained by mixing and sintering the SrCO₃ powder and the Nb₂O₅ powder. The tenacity and drop resistance performance of the Zr-based composite ceramic material may be effectively improved by dispersing the cubic Sr_{0.82}NbO₃ stable phase, the Ca₁₀(PO₄)₆(OH)₂ phase and the SrAl₁₂O₁₉ phase within the zirconia matrix (inside and on a surface thereof), such that the Zr-based composite ceramic material may be suitably used to manufacture an appearance part having a large area, such as a shell or a decoration.

It should be noted that the Ca₁₀(PO₄)₆(OH)₂ powder may be commercially purchased from, for example, Shanxi Sealong Biological & Chemical co., LTD; and the SrAl₁₂O₁₉ powder may be commercially purchased or manufactured according to a common method.

In some embodiments, the SrAl₁₂O₁₉ powder is manufactured by: mixing and milling (for example ball-milling) a compound containing Sr (for example, an oxide containing Sr, a carbonate containing Sr or a nitrate containing Sr) and a compound containing Al (for example, an oxide containing Al, a carbonate containing Al or a nitrate containing Al) according to a certain ratio (for example, a molar ratio of Sr in the compound containing Sr to Al in the compound containing Al of about 1:12) to form a mixture, then sintering the mixture at a temperature kept in a range from 1350 Celsius degrees to 1450 Celsius degrees, for example at a temperature of 1400 Celsius degrees for 1 hour to 2 hours to form a sinter, and then milling (such as ball milling) and crushing the sinter to form a powder in micron size, i.e the SrAl₁₂O₁₉ powder.

It should be noted that there is no particular limitation for a mixing method of these raw materials (namely the zirconia powder, the Ca₁₀(PO₄)₆(OH)₂ powder, the SrAl₁₂O₁₉ powder, the SrCO₃ powder, the Nb₂O₅ powder and the binder), any common mixing method in the art may be adopted. In some embodiments, preparing a mixed slurry by mixing a zirconia powder, a Ca₁₀(PO₄)₆(OH)₂ powder, a SrAl₁₂O₁₉ powder, a SrCO₃ powder, a Nb₂O₅ powder and a binder includes: preparing a pre-mixture by mixing and milling (for example, ball milling) the zirconia powder, the Ca₁₀(PO₄)₆(OH)₂ powder, the SrAl₁₂O₁₉ powder, the SrCO₃ powder, and the Nb₂O₅ powder; and obtaining the mixed slurry by mixing and milling (for example, ball milling) the pre-mixture and the binder. By this way, these raw materials may be distributed more evenly in the mixed slurry, which may be good for obtaining a Zr-based composite ceramic material having a better tenacity and drop resistance performance and a more uniform color.

It should be noted that there is no particular limitation for a ratio of the zirconia powder, the Ca₁₀(PO₄)₆(OH)₂ powder, the SrAl₁₂O₁₉ powder, the SrCO₃ powder, and the Nb₂O₅ powder, as long as the cubic Sr_{0.82}NbO₃ stable phase, the Ca₁₀(PO₄)₆(OH)₂ phase, the SrAl₁₂O₁₉ phase are contained in the prepared Zr-based composite ceramic material. In order to optimize the tenacity and chroma of the Zr-based composite ceramic material, in some embodiments, a molar ratio of the zirconia powder, the Ca₁₀(PO₄)₆(OH)₂ powder, the SrAl₁₂O₁₉ powder and the SrCO₃ powder is 100:(0.05-1):(0.13-0.83):(0.164-6.56), such as 100:(0.1-0.7):(0.17-0.75):(0.8-5). In some embodiments, the zirconia powder is a tetragonal zirconia stabilized with 3 mol % of yttrium.

It should be noted that there are no particular limitations for both type and amount of the binder, which may be selected according to a conventional technical means in the art. For example, the binder may be, but not limited to, PVA or polyethylene glycol 4000, and the amount of the binder may be 0.2 wt % to about 2 wt % based on a total weight of the zirconia powder.

It should be noted that there are no particular limitations for technological conditions of the drying step, and the drying step may be carried out according to a common used drying method in the art. For example, in one embodiment, the drying step is carried out by adopting a spray drying under conditions of: an air inlet temperature of about 220 Celsius degrees to about 260 Celsius degrees, an air outlet temperature of about 100 Celsius degrees to about 125 Celsius degrees, and a centrifugal rotational speed of about 10 rpm to about 20 rpm.

It should be noted that there are no particular limitations for technological conditions of the molding step, and the molding step may be carried out by adopting a dry pressing, an isostatic compaction, an injection molding, a hot pressing casting or other conventional molding methods. For example, in one embodiment of the present disclosure, the molding step is carried out by adopting a dry pressing with a press having a tonnage of about 150 tons to about 200 tons under a dry pressure of about 6 MPa to about 12 MPa for about 20 seconds to about 60 seconds.

It should be noted that there are no particular limitations for technological conditions of the sintering step. In one embodiment, the sintering step is carried out by adopting an air pressure sintering with an ordinary muffle furnace. For example, the sintering step is carried out at a temperature of about 1350 Celsius degrees to about 1500 Celsius degrees, for example, about 1390 Celsius degrees to about 1480 Celsius degrees, such as, about 1430 Celsius degrees to about 1470 Celsius degrees, for about 1 hour to about 2 hours.

In some embodiments of the present disclosure, the sintering step includes: heating a preformed part obtained in the molding step from room temperature up to a temperature ranging from about 550 Celsius degrees to about 650 Celsius degrees within about 350 minutes to about 450 minutes, and then holding for about 1.5 hours to about 2.5 hours; raising the temperature up to about 1100 Celsius degrees to about 1200 Celsius degrees within about 250 minutes to about 350 minutes, and then holding for about 1.5 hours to about 2.5 hours; raising the temperature up to about 1250 Celsius degrees to about 1350 Celsius degrees within about 120 minutes to about 180 minutes, and then holding for about 1.5 hours to about 2.5 hours; raising the temperature up to about 1430 Celsius degrees to about 1470 Celsius degrees within about 30 minutes to about 60 minutes, and then holding for about 1 hour to about 2 hours; dropping the temperature to about 900 Celsius degrees within about 120 minutes to about 180 minutes; and then naturally dropping the temperature to room temperature.

It should be noted that there are no particular limitations for milling step, as long as these raw materials may be blended sufficiently. In some embodiments, the milling step is carried out by adopting a ball milling using a ball milling pot with a zirconia ceramic lining and a zirconia mill ball.

It should be noted that, generally, a ball milling liquid should be added during the ball milling. For example, in the present disclosure, the ball milling liquid may be at least one selected from, but not limited to, water and C₁-C₅ alcohols. In some embodiments, the ball milling liquid is at least one selected from water and C₁-C₅ monohydric alcohols. The C₁-C₅ monohydric alcohols may be at least one selected from: methyl alcohol, ethyl alcohol, n-propyl alcohol, 2-propyl alcohol, n-butyl alcohol, 2-butyl alcohol, 2-methyl-1-propyl alcohol, 2-methyl-2-propyl alcohol, n-amyl alcohol, 2-methyl-1-butanol, 3-methyl-1-butanol, 2-methyl-2-butanol, 3-methyl-2-butanol and 2,2-dimethyl-1-propyl alcohol. In some embodiments, the ball milling liquid is selected from at least one of water and ethyl alcohol.

The present disclosure further provides a Zr-based composite ceramic material prepared by the method mentioned above. The Zr-based composite ceramic material includes a zirconia matrix, a cubic Sr_{0.82}NbO₃ stable phase, a Ca₁₀(PO₄)₆(OH)₂ phase, and a SrAl₁₂O₁₉ phase, and the cubic Sr_{0.82}NbO₃ stable phase, the Ca₁₀(PO₄)₆(OH)₂ phase and the SrAl₁₂O₁₉ phase are dispersed within the zirconia matrix.

In some embodiments, the Zr-based composite ceramic material includes about 0.2 mol % to about 8 mol % of the cubic Sr_{0.82}NbO₃ stable phase, about 0.05 mol % to about 1 mol % of the Ca₁₀(PO₄)₆(OH)₂ phase, and about 0.13 mol % to about 0.83 mol % of the SrAl₁₂O₁₉ phase, based on 100 mol % of zirconia matrix. In some embodiments, the Zr-based composite ceramic material includes about 1 mol % to about 6.1 mol % of the cubic Sr_{0.82}NbO₃ stable phase, about 0.1 mol % to about 0.7 mol % of the Ca₁₀(PO₄)₆(OH)₂ phase, and about 0.17 mol % to about 0.75 mol % of the SrAl₁₂O₁₉ phase, based on 100 mol % of the zirconia matrix. In some embodiments, the Zr-based composite ceramic material has a CIELab color value L of about 89 to about 92, a CIELab color value a of about 0.01 to about 0.5, and a CIELab color value b of about 0.01 to about 0.5.

In the method for preparing the Zr-based composite ceramic material of the present disclosure, it is presumed that the SrCO₃ (strontium carbonate) powder and the Nb₂O₅ (niobium pentoxide) powder may achieve a complete reaction to generate the cubic Sr_{0.82}NbO₃ stable phase, therefore, the content of the cubic Sr_{0.82}NbO₃ stable phase in the prepared Zr-based composite ceramic material is determined by a feed ratio of the SrCO₃ (strontium carbonate) powder to the Nb₂O₅ (niobium pentoxide) powder.

The present disclosure further provides a shell or a decoration, the shell or the decorative element is made of the Zr-based composite ceramic material mentioned above and thus may have a relatively good tenacity and drop resistance performance. Moreover, by reasonably regulating a content of structure phase in the Zr-based composite ceramic material, the shell or the decoration may have a pure color (for example, milk white) and a more shining surface.

The Zr-based composite ceramic material, the method for preparing the Zr-based composite ceramic material of the present disclosure, and advantageous effects thereof will be further described hereinafter by referring to Examples and Comparative Examples.

### 1. DESCRIPTION OF RAW MATERIALS

(1) Zirconia powder: OZ-3Y-7 (particle size D50: 0.7 microns) purchased from Guangdong Orient Zirconic Ind Sci&Tech Co., Ltd, which is a tetragonal phase zirconia powder stabilized with 3 mol % of yttrium.

(2) SrCO₃ powder: purchased from Shanghai Dian Yang Industry Co., LTD with a purity of 99% and a particle size D50 of 1 micron.

(3) Nb₂O₅ power: purchased from Yangzhou Sanhe Chemical Co., LTD with a purity of 99.5% and a particle size D50 of 1 micron.

(4) Ca₁₀(PO₄)₆(OH)₂ powder: purchased from Shanxi Sealong Biological & Chemical co., LTD, which has a particle size D50 of 0.5 microns and a purity of 99.5%.

(5) SrAl₁₂O₁₉ powder (particle size D50 of 0.5 micron): obtained by mixing and ball milling SrCO₃ and Al₂O₃ at a molar ratio of 1:6, then drying and followed by sintering the obtained mixture at a temperature of 1400 Celsius degrees for 1.5 hours to form a sinter, and then ball milling and crushing the sinter to a powder in micron size.

(6) Binder: polyethylene glycol 4000 and PVA217 both purchased from Kuraray company.

### 2. TESTIFYING EXAMPLES

In X-ray diffraction phase analysis of the following Testifying Example 1 and Testifying Example 2:

Test Instrument: X-ray diffraction phase analyzer.

Test Conditions: CuKa radiation, pipe voltage: 40 KV, pipe current: 20 mA, scanning pattern: theta/2theta (θ/2θ), scanning mode: continue, scanning range: 10 degrees to 80 degrees, stepping angle: 0.04 degrees.

### Testifying Example 1

This Testifying Example is used to prove that the cubic Sr_{0.82}NbO₃ stable phase cannot be obtained by sintering the Nb₂O₅ power and the SrCO₃ powder in air with a molar ratio of the Nb₂O₅ power to the SrCO₃ powder of 1:1.64.

Raw materials: Nb₂O₅ power and SrCO₃ powder, a molar ratio of the Nb₂O₅ power to the SrCO₃ powder was 1:1.64.

Preparation Process:

The Nb₂O₅ power and the SrCO₃ powder were ball milled in a balling mill pot for 8 hours with addition of ethyl alcohol to form a mixture, and then the mixture was dried.

The dried mixture was heated up to 600 Celsius degrees from room temperature within 400 minutes and held for 2 hours; then heated up to 1150 Celsius degrees within 300 minutes and held for 2 hours; then heated up to 1300 Celsius degrees within 150 minutes and held for 2 hours, then heated up to 1450 Celsius degrees within 50 minutes and held for 1.5 hours; then cooled down to 900 Celsius degrees within 150 minutes, and then naturally cooled down to room temperature to obtain a sinter, which was marked as P1.

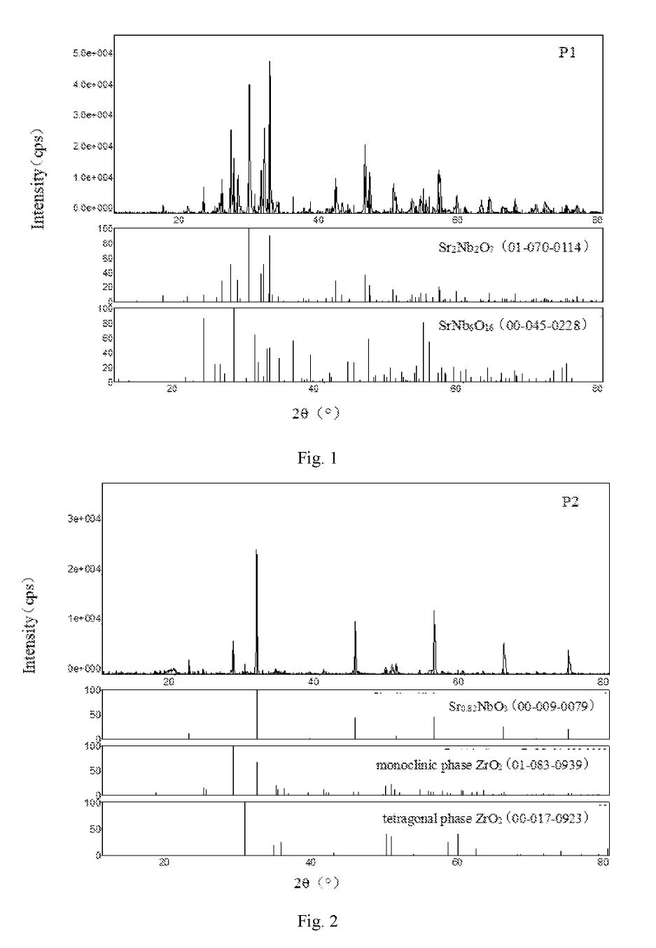

Result of X-ray diffraction phase analysis: FIG. 1 shows a XRD diffraction pattern of P1 prepared in Testifying Example 1 and standard cards of SrNb₆O₁₆ (00-045-0228) and Sr₂Nb₂O₇ (01-070-0114). As shown in FIG. 1, the sinter P1 mainly contains the SrNb₆O₁₆ phase and the Sr₂Nb₂O₇ phase, but without the cubic Sr_{0.82}NbO₃ stable phase. That is, the cubic Sr_{0.82}NbO₃ stable phase cannot be obtained by sintering the Nb₂O₅ power and the SrCO₃ powder in air with the molar ratio of the Nb₂O₅ power to the SrCO₃ powder of 1:1.64.

### Testifying Example 2

This Testifying Example is used to prove that the cubic Sr_{0.82}NbO₃ stable phase may be obtained by sintering the Nb₂O₅ power and the SrCO₃ powder in the zirconia matrix with a molar ratio of the Nb₂O₅ power to the SrCO₃ powder of 1:1.64.

Raw materials: 200 grams of zirconia powder, Nb₂O₅ power in an amount of 25 mol % based on the total mole of the zirconia powder, and SrCO₃ powder, the molar ratio of the Nb₂O₅ power to the SrCO₃ powder was 1:1.64.

Preparation Process:

The zirconia powder, the Nb₂O₅ power and the SrCO₃ powder were ball milled in a ball milling pot for 8 hours with addition of ethyl alcohol to form a mixture, and then the mixture was dried.

The dried mixture was heated up to 600 Celsius degrees from room temperature within 400 minutes, and held for 2 hours; then heated up to 1150 Celsius degrees within 300 minutes, and held for 2 hours; then heated up to 1300 Celsius degrees within 150 minutes, and held for 2 hours, then heated up to 1450 Celsius degrees within 50 minutes, and held for 1.5 hours; then cooled down to 900 Celsius degrees within 150 minutes, and then naturally cooled down to room temperature to obtain a sinter, which was marked as P2.

Result of X-ray diffraction phase analysis: FIG. 2 shows a XRD diffraction pattern of P2 prepared in Testifying Example 2 and standard cards of tetragonal phase zirconia (00-017-0923), monoclinic phase zirconia (01-083-0939) and Sr_{0.82}NbO₃ (00-009-0079). As shown in FIG. 2, the sinter P2 contains the tetragonal phase zirconia, the monoclinic phase zirconia and the cubic Sr_{0.82}NbO₃ stable phase. That is, the cubic Sr_{0.82}NbO₃ stable phase may be obtained by sintering the Nb₂O₅ power and the SrCO₃ powder in the zirconia matrix with the molar ratio of the Nb₂O₅ power to the SrCO₃ powder of 1:1.64.

In conclusion, as can be seen from the results of X-ray diffraction phase analysis of Testifying Example 1 and Testifying Example 2, the cubic Sr_{0.82}NbO₃ stable phase may be obtained by mixing the Nb₂O₅ power and the SrCO₃ powder at a molar ratio of the Nb₂O₅ power to the SrCO₃ powder of 1:1.64 under certain cases and conditions, instead of any cases and conditions. Inventors of the present disclosure have occasionally found that the cubic Sr_{0.82}NbO₃ stable phase may be obtained by sintering the Nb₂O₅ power and the SrCO₃ powder mixed in the zirconia matrix with a molar ratio of the Nb₂O₅ power to the SrCO₃ powder of 1:1.64. Based on this, inventors of the present disclosure provide the Zr-based composite ceramic material and the preparation method thereof in the present disclosure.

### 3. EXAMPLES 1-6 AND COMPARATIVE EXAMPLES 1-5

### Example 1

This example is used to illustrate the Zr-based composite ceramic material of the present disclosure and the preparation method thereof.

Raw material: 200 grams of zirconia powder, Ca₁₀(PO₄)₆(OH)₂ powder in an amount of 0.5 mol % based on total mole of the zirconia powder, SrAl₁₂O₁₉ powder in an amount of 0.46 mol % based on total mole of the zirconia powder, SrCO₃ powder in an amount of 1.5 mol % based on total mole of the zirconia powder, Nb₂O₅ power in a molar ratio of the Nb₂O₅ power to the SrCO₃ powder of 1:1.64, a polyethylene glycol 4000 in an amount of 0.5 wt % based on the total weight of the zirconia powder, and PVA in an amount of 0.5 wt % based on the total weight of the zirconia powder.

Preparation Process:

The zirconia powder, the Ca₁₀(PO₄)₆(OH)₂ powder, the SrAl₁₂O₁₉ powder, the SrCO₃ powder and the Nb₂O₅ power were ball milled in a ball milling pot with addition of ethyl alcohol for 8 hours to obtain a pre-mixture, then the polyethylene glycol 4000 and PVA were added into the pre-mixture and ball milled for 0.5 hours to obtain a slurry.

The slurry was fed into a spray tower and spray dried under conditions of: an air inlet temperature of 250 Celsius degrees, an air outlet temperature of 110 Celsius degrees, and a centrifugal rotational speed of 21 rpm, to form a spherical powder. The spherical powder was fed into a dry press (which has a tonnage of 180 tons and an oil pressure of 8 MPa) and dry pressed for 30 seconds to form a preformed part. The preformed part was heated up to 600 Celsius degrees from room temperature within 400 minutes and held for 2 hours; then heated up to 1150 Celsius degrees within 300 minutes and held for 2 hours; then heated up to 1300 Celsius degrees within 150 minutes and held for 2 hours; then heated up to 1450 Celsius degrees within 50 minutes and held for 1.5 hours; then cooled down to 900 Celsius degrees within 150 minutes; and then naturally cooled down to room temperature to obtain the Zr-based composite ceramic material.

It is presumed according to the feed stoichiometric ratio that, the obtained Zr-based composite ceramic material contains 1.83 mol % of the cubic Sr_{0.82}NbO₃ stable phase, 0.5 mol % of Ca₁₀(PO₄)₆(OH)₂ phase, and 0.46 mol % of SrAl₁₂O₁₉ phase, based on 100 mol % of the zirconia powder.

The obtained Zr-based composite ceramic material was polished and laser cut into a sample having a length of 135 millimeters, a width of 65 millimeters and a thickness of 0.7 millimeters, and marked as S1.

### Example 2

This example is used to illustrate the Zr-based composite ceramic material of the present disclosure and the preparation method thereof.

Raw material: the raw materials of this example is the same as Example 1, except that: the amount of the Ca₁₀(PO₄)₆(OH)₂ powder was 0.1 mol % based on total mole of the zirconia powder, the amount of the SrAl₁₂O₁₉ powder was 0.17 mol % based on total mole of the zirconia powder.

Preparation Process:

The preparation process of this example is the same as Example 1.

It is presumed according to the feed stoichiometric ratio that, the obtained Zr-based composite ceramic material contains 1.83 mol % of cubic Sr_{0.82}NbO₃ stable phase, 0.1 mol % of Ca₁₀(PO₄)₆(OH)₂ phase, and 0.17 mol % of SrAl₁₂O₁₉ phase, based on 100 mol % of the zirconia powder.

The obtained Zr-based composite ceramic material was polished and laser cut into a sample having a length of 135 millimeters, a width of 65 millimeters and a thickness of 0.7 millimeters, and marked as S2.

### Example 3

This example is used to illustrate the Zr-based composite ceramic material of the present disclosure and the preparation method thereof.

Raw material: the raw materials of this example is the same as Example 1, except that: the amount of the SrCO₃ powder was 5 mol % based on total mole of the zirconia powder, the molar ratio of the Nb₂O₅ powder to the SrCO₃ powder was 1:1.64.

Preparation Process:

The preparation process of this example is the same as Example 1.

It is presumed according to the feed stoichiometric ratio that, the obtained Zr-based composite ceramic material contains 6.1 mol % of cubic Sr_{0.82}NbO₃ stable phase, 0.5 mol % of Ca₁₀(PO₄)₆(OH)₂ phase, and 0.46 mol % of SrAl₁₂O₁₉ phase, based on 100 mol % of the zirconia powder.

The obtained Zr-based composite ceramic material was polished and laser cut into a sample having a length of 135 millimeters, a width of 65 millimeters and a thickness of 0.7 millimeters, and marked as S3.

### Example 4

This example is used to illustrate the Zr-based composite ceramic material of the present disclosure and the preparation method thereof.

Raw material: the raw materials of this example was the same as Example 1, except that: the amount of the Ca₁₀(PO₄)₆(OH)₂ powder was 0.7 mol % based on total mole of the zirconia powder, the amount of the SrAl₁₂O₁₉ powder was 0.75 mol % based on total mole of the zirconia powder, the amount of the SrCO₃ powder was 0.82 mol % based on total mole of the zirconia powder, the molar ratio of the Nb₂O₅ powder to the SrCO₃ powder was 1:1.64.

Preparation Process:

The preparation process of this example is the same as Example 1.

It is presumed according to the feed stoichiometric ratio that, the obtained Zr-based composite ceramic material contains 1 mol % of cubic Sr_{0.82}NbO₃ stable phase, 0.7 mol % of Ca₁₀(PO₄)₆(OH)₂ phase, and 0.75 mol % of SrAl₁₂O₁₉ phase, based on 100 mol % of the zirconia powder.

The obtained Zr-based composite ceramic material was polished and laser cut into a sample having a length of 135 millimeters, a width of 65 millimeters and a thickness of 0.7 millimeters, and marked as S4.

### Example 5

This example is used to illustrate the Zr-based composite ceramic material of the present disclosure and the preparation method thereof.

Raw material: the raw materials of this example was the same as Example 1, except that: the amount of the zirconia powder was 200 grams, the amount of the Ca₁₀(PO₄)₆(OH)₂ powder was 1 mol % based on total mole of the zirconia powder, the amount of the SrAl₁₂O₁₉ powder was 0.83 mol % based on total mole of the Zirconia powder, the amount of the SrCO₃ powder was 6.56 mol % based on total mole of the zirconia powder, the molar ratio of the Nb₂O₅ powder to the SrCO₃ powder was 1:1.64.

Preparation Process:

The preparation process of this example is the same as Example 1.

It is presumed according to the feed stoichiometric ratio that, the obtained Zr-based composite ceramic material contains 8 mol % of cubic Sr_{0.82}NbO₃ stable phase, 1 mol % of Ca₁₀(PO₄)₆(OH)₂ phase, and 0.83 mol % of SrAl₁₂O₁₉ phase, based on 100 mol % of the zirconia powder.

The obtained Zr-based composite ceramic material was polished and laser cut into a sample having a length of 135 millimeters, a width of 65 millimeters and a thickness of 0.7 millimeters, and marked as S5.

### Example 6

This example is used to illustrate the Zr-based composite ceramic material of the present disclosure and the preparation method thereof.

Raw material: 200 grams of the zirconia powder, Ca₁₀(PO₄)₆(OH)₂ powder in an amount of 0.05 mol % based on total mole of the zirconia powder, SrAl₁₂O₁₉ powder in an amount of 0.13 mol % based on total mole of the zirconia powder, SrCO₃ powder in an amount of 0.2 mol % based on total mole of the zirconia powder, Nb₂O₅ power with a molar ratio of the Nb₂O₅ powder to the SrCO₃ powder of 1:1.64, polyethylene glycol 4000 in an amount of 0.5 wt % based on total weight of the zirconia powder, and PVA in an amount of 0.5 wt % based on total weight of the zirconia powder.

Preparation Process:

The preparation process of this example is the same as Example 1.

It is presumed according to the feed stoichiometric ratio that, the obtained Zr-based composite ceramic material contains 0.24 mol % of cubic Sr_{0.82}NbO₃ stable phase, 0.05 mol % of Ca₁₀(PO₄)₆(OH)₂ phase, and 0.13 mol % of SrAl₁₂O₁₉ phase, based on 100 mol % of the Zirconia powder.

The obtained Zr-based composite ceramic material was polished and laser cut into a sample having a length of 135 millimeters, a width of 65 millimeters and a thickness of 0.7 millimeters, and marked as S6.

### Comparative Example 1

This Comparative Example is used to comparatively illustrate the Zr-based composite ceramic material of the present disclosure and the preparation method thereof.

(1) Raw material: 200 grams of zirconia powder, polyethylene glycol 4000 in an amount of 0.5 wt % based on the total weight of the zirconia powder, and PVA in an amount of 0.5 wt % based on the total weight of the Zirconia powder.

(2) Preparation Process of Ceramic Material:

The zirconia powder, polyethylene glycol 4000 and PVA were ball milled for 0.5 hours to obtain a slurry.

The slurry was fed into a spray tower and spray dried under conditions of: an air inlet temperature of 250 Celsius degrees, an air outlet temperature of 110 Celsius degrees, and a centrifugal rotational speed of 15 rpm, to form a spherical powder. The spherical powder was fed into a dry press (which has a tonnage of 180 tons and an oil pressure of 8 MPa) and dry pressed for 30 seconds to form a preformed part. The preformed part was heated up to 1480 Celsius degrees and sintered for 2 hours, and then cooled down to room temperature to obtain the ceramic material.

The obtained ceramic material was polished and laser cut into a sample having a length of 135 millimeters, a width of 65 millimeters and a thickness of 0.7 millimeters, and marked as D1.

### Comparative Example 2

This Comparative Example is used to comparatively illustrate the Zr-based composite ceramic material of the present disclosure and the preparation method thereof.

(1) Raw material: 200 grams of zirconia powder, Ca₁₀(PO₄)₆(OH)₂ powder in an amount of 1.5 mol % based on total mole of the zirconia powder, SrAl₁₂O₁₉ powder in an amount of 0.46 mol % based on total mole of the zirconia powder, polyethylene glycol 4000 in an amount of 0.5 wt % based on total weight of the zirconia powder, and PVA in an amount of 0.5 wt % based on total weight of the zirconia powder.

(2) Preparation Process of Ceramic Material:

The preparation process of this Comparative Example is the same as Comparative Example 1, except that:

The zirconia powder, Ca₁₀(PO₄)₆(OH)₂ powder and the SrAl₁₂O₁₉ powder were ball milled in a ball milling pot with addition of ethyl alcohol for 8 hours to form a pre-mixture, then the polyethylene glycol 4000 and PVA were added into the pre-mixture and ball milled for 0.5 hours to obtain a slurry.

The obtained ceramic material was polished and laser cut into a sample having a length of 135 millimeters, a width of 65 millimeters and a thickness of 0.7 millimeters, and marked as D2.

### Comparative Example 3

This Comparative Example is used to comparatively illustrate the Zr-based composite ceramic material of the present disclosure and the preparation method thereof.

(1) Raw material: 200 grams of zirconia powder, SrCO₃ powder in an amount of 8 mol % based on total mole of the zirconia powder, Nb₂O₅ powder with a molar ratio of the Nb₂O₅ powder to the SrCO₃ powder of 1:1.64, polyethylene glycol 4000 in an amount of 0.5 wt % based on total weight of the zirconia powder, and PVA in an amount of 0.5 wt % based on total weight of the zirconia powder.

(2) Preparation Process of Ceramic Material:

The preparation process of this Comparative Example is the same as Comparative Example 1, except that:

The zirconia powder, the SrCO₃ powder and the Nb₂O₅ powder were ball milled in a ball milling pot with addition of ethyl alcohol for 8 hours to form a pre-mixture, then the polyethylene glycol 4000 and PVA were added into the pre-mixture and ball milled for 0.5 hours to obtain a slurry.

The obtained ceramic material was polished and laser cut into a sample having a length of 135 millimeters, a width of 65 millimeters and a thickness of 0.7 millimeters, and marked as D3.

### Comparative Example 4

This Comparative Example (referring to Example 1 in Chinese Patent No. 02111146.4) is used to comparatively illustrate the Zr-based composite ceramic material of the present disclosure and the preparation method thereof.

0.5 vol % of ultra-fine YAS sintering aid and (Mg, Y)-TZP powder ((14 mol %)MgO-(1.5 mol %)Y₂O₃-(balance)ZrO₂) were mechanically ball milled for about 12 hours, and then dried. After that, PVA binder having a concentration of 3% was added to form a mixture, which was pelleted and dry pressed under a pressure of 60 MPa, and then isostatic pressed under a pressure of 200 MPa to obtain a biscuit. Subsequently, the biscuit was placed into a silicon molybdenum furnace and heated up to 1400 Celsius degrees at a heating rate of 2 Celsius degrees per minute and held for 2 hours, and then naturally cooled in the furnace to obtain a sinter.

The sinter was polished and laser cut into a sample having a length of 135 millimeters, a width of 65 millimeters and a thickness of 0.7 millimeters, and the sample was marked as D4.

### Comparative Example D5

This Comparative Example is used to comparatively illustrate the Zr-based composite ceramic material of the present disclosure and the preparation method thereof.

(1) Raw material: 200 grams of zirconia powder, Sr₂Nb₂O₇ powder in an amount of 1.83 mol % based on total mole of the zirconia powder, polyethylene glycol 4000 in an amount of 0.5 wt % based on total weight of the zirconia powder, and PVA in an amount of 0.5 wt % based on total weight of the zirconia powder. The Sr₂Nb₂O₇ powder was obtained by ball-milling and mixing the SrCO₃ powder and the Nb₂O₅ powder at a molar ratio of the SrCO₃ powder to the Nb₂O₅ powder of 2:1 to form a mixture, then subjecting the mixture to drying, and followed by sintering at 1200 Celsius degrees for 1.5 hours to form a sinter, and then ball milling and crushing the sinter to obtain a powder having a particle size D50 of 0.5 microns.

(2) Preparation Process of Ceramic Material:

The preparation process of this Comparative Example is the same as Comparative Example 1, except that:

The zirconia powder and the Sr₂Nb₂O₇ powder were ball milled in a ball milling pot with addition of ethyl alcohol for 8 hours to form a pre-mixture, then the polyethylene glycol 4000 and PVA were added into the pre-mixture and ball milled for 0.5 hours to obtain a slurry.

The obtained Zr-based ceramic material was polished and laser cut into a sample having a length of 135 millimeters, a width of 65 millimeters and a thickness of 0.7 millimeters, and marked as D5.

### 4. TEST

Performance tests were carried out for samples S1-S6 prepared respectively in Examples 1-6 and samples D1-D5 prepared respectively in Comparative Examples 1-5 so as to illustrate advantageous effects of the Zr-based composite ceramic material of the present disclosure and the preparation method thereof.

(1) Test Items and Methods

(a) Chroma test: CIELab color values L, a, and b of these samples were tested by a colorimeter (China-color1101 of Nuo Su Electronic Technology Co., Ltd) and these samples were compared with a standard sample of blacked carbon black.

(b) Tenacity test was performed according to GB/T23806 precision ceramics fracture toughness test method, namely single edge notched beam method.

(c) Drop resistance performance test: Ten samples for each of Examples 1-6 and Comparative Examples 1-5 were dropped from a height of 1.3 meters in a free fall manner with their large surfaces being in vertical contact with the ground, and an average anti-drop count was recorded.

(d) Polishing effect: samples S1-S6 and D1-D5 were observed through naked-eye to see if there was any defect on their surface.

(2) Test result: as shown in Table 1.

TABLE 1

| | | | | | Drop | |
|---|---|---|---|---|---|---|
| | Chroma | | | Tenacity | resistance | |
| Sample | L | a | b | (MPa • m^{1/2}) | (Count) | Polishing effect |
| S1 | 92 | 0.02 | 0.04 | 15 | 16 | mirror surface with no defect |
| S2 | 91 | 0.07 | 0.1 | 14 | 12 | mirror surface with no defect |
| S3 | 90.5 | 0.05 | 0.1 | 13 | 10 | mirror surface with no defect |
| S4 | 89 | 0.2 | 0.3 | 12 | 10 | mirror surface with no defect |
| S5 | 90 | 0.3 | 0.2 | 9 | 7 | mirror surface with no defect |
| S6 | 89.5 | 0.1 | 0.4 | 7 | 5 | mirror surface with no defect |
| D1 | 85 | 1.6 | 1 | 5.5 | 1 | mirror surface with no defect |
| D2 | 90 | 0.1 | 0.1 | 6 | 1 | mirror surface with no defect |
| D3 | 84 | −1 | −0.9 | 6 | 2 | mirror surface with no defect |
| D4 | 82 | −1.5 | −0.9 | 7 | 2 | mirror surface with a few micropores |
| D5 | 85 | 1.2 | 0.7 | 10 | 9 | mirror surface with no defect |

As can be seen from Table 1, samples S1-S6 prepared according to the method for preparing the Zr-based composite ceramic materials of the present disclosure have a tenacity significantly better than that of the sampled D1-D4, and can stand drop resistance performance test 5 times, even 12 times to 16 times at a particular condition.

Moreover, as compared to the sample D5 prepared in Comparative Example 5 with addition of Sr₂Nb₂O₇ powder, the tenacity and drop resistance performance of the samples S5-S6 of the present disclosure are approximate to that of the sample D5, and the tenacity and drop resistance performance of the samples S1-S4 of the present disclosure are much better than that of the sample D5.

In addition, with a certain raw material ratio or content of structure phase, samples S1-S6 of the present disclosure have a CIELab color value L in a range of 89-92, a CIELab color value a in a range of 0.01-0.5, and a CIELab color value b in a range of 0.01-0.5. That is, the ceramic materials obtained in the present disclosure have a milk white color, which may be popular among the adult population.

Although embodiments of the present disclosure have been shown and described, those ordinary skilled in the art can understand that multiple changes, modifications, replacements, and variations may be made to these embodiments without departing from the principle and purpose of the present disclosure.

It should be noted that, specific technical characteristics and embodiments described hereinbefore can be combined in any suitable way without contradiction and departing from the principle of the present disclosure, which also falls into the scope of the present disclosure.

1. A Zr-based composite ceramic material, comprising:
a zirconia matrix,
a cubic Sr_{0.82}NbO₃ stable phase,
a Ca₁₀(PO₄)₆(OH)₂ phase, and
a SrAl₁₂O₁₉ phase,
wherein the cubic Sr_{0.82}NbO₃ stable phase, the Ca₁₀(PO₄)₆(OH)₂ phase, and the SrAl₁₂O₁₉ phase are dispersed within the zirconia matrix.

2. The Zr-based composite ceramic material of claim 1, wherein, based on 100 mol % of the zirconia matrix:
the cubic Sr_{0.82}NbO₃ stable phase is about 0.2 mol % to about 8 mol %,
the Ca₁₀(PO₄)₆(OH)₂ phase is about 0.05 mol % to about 1 mol %, and
the SrAl₁₂O₁₉ phase is about 0.13 mol % to about 0.83 mol %.

3. The Zr-based composite ceramic material of claim 2, wherein:
the cubic Sr_{0.82}NbO₃ stable phase is about 1 mol % to about 6.1 mol %,
the Ca₁₀(PO₄)₆(OH)₂ phase is about 0.1 mol % to about 0.7 mol %, and
the SrAl₁₂O₁₉ phase is about 0.17 mol % to about 0.75 mol %.

4. The Zr-based composite ceramic material of claim 3, wherein the zirconia matrix is a zirconia matrix stabilized with about 3 mol % of yttrium.

5. The Zr-based composite ceramic material of claim 4, wherein the cubic Sr_{0.82}NbO₃ stable phase in the Zr-based composite ceramic material is formed by adding and sintering a SrCO₃ powder and a Nb₂O₅ power during preparation of the Zr-based composite ceramic material.

6. The Zr-based composite ceramic material of claim 5, wherein the Zr-based composite ceramic material has a CIELab color value L of about 89 to about 92, a CIELab color value a of about 0.01 to about 0.5, and a CIELab color value b of about 0.01 to about 0.5.

7. A method for preparing a Zr-based composite ceramic material, comprising:
preparing a mixed slurry by mixing a zirconia powder, a Ca₁₀(PO₄)₆(OH)₂ powder, a SrAl₁₂O₁₉ powder, a SrCO₃ powder, a Nb₂O₅ powder and a binder; and
obtaining the Zr-based composite ceramic material by drying, molding and sintering the mixed slurry in sequence,
wherein a molar ratio of the SrCO₃ powder to the Nb₂O₅ powder is 1.64:1.

8. The method of claim 7, wherein a molar ratio of the zirconia powder, the Ca₁₀(PO₄)₆(OH)₂ powder, the SrAl₁₂O₁₉ powder and the SrCO₃ powder is 100:(0.05-1):(0.13-0.83):(0.164-6.56).

9. The method of claim 8, wherein a molar ratio of the zirconia powder, the Ca₁₀(PO₄)₆(OH)₂ powder, the SrAl₁₂O₁₉ powder and the SrCO₃ powder is 100:(0.1-0.7):(0.17-0.75):(0.8-5).

10. The method of claim 9, wherein the zirconia powder is a tetragonal phase zirconia powder stabilized with about 3 mol % of yttrium.

11. The method of claim 10, wherein the drying step is carried out by a spray drying under conditions of: an air inlet temperature of about 220 Celsius degrees to about 260 Celsius degrees, an air outlet temperature of about 100 Celsius degrees to about 125 Celsius degrees, and a centrifugal rotational speed of about 10 rpm to about 20 rpm.

12. The method of claim 11, wherein the molding step is carried out by adopting a dry pressing with a press having a tonnage of about 150 tons to about 200 tons under a dry pressure of about 6 MPa to about 12 MPa for about 20 seconds to about 60 seconds.

13. The method of claim 12, wherein the sintering step is carried out at a temperature of about 1430 Celsius degrees to about 1470 Celsius degrees for about 1 hour to about 2 hours.

14. The method of claim 13, wherein preparing a mixed slurry by mixing a zirconia powder, a Ca₁₀(PO₄)₆(OH)₂ powder, a SrAl₁₂O₁₉ powder, a SrCO₃ powder, a Nb₂O₅ powder and a binder comprises:
preparing a pre-mixture by mixing and milling the zirconia powder, the Ca₁₀(PO₄)₆(OH)₂ powder, the SrAl₁₂O₁₉ powder, the SrCO₃ powder, and the Nb₂O₅ powder; and
obtaining the mixed slurry by mixing and milling the pre-mixture and the binder.

15. The method of claim 14, wherein the sintering step comprises:
heating a preformed part obtained in the molding step from room temperature up to a temperature ranging from about 550 Celsius degrees to about 650 Celsius degrees within about 350 minutes to about 450 minutes, and then holding for about 1.5 hours to about 2.5 hours;
raising the temperature up to about 1100 Celsius degrees to about 1200 Celsius degrees within about 250 minutes to about 350 minutes, and then holding for about 1.5 hours to about 2.5 hours;
raising the temperature up to about 1250 Celsius degrees to about 1350 Celsius degrees within about 120 minutes to about 180 minutes, and then holding for about 1.5 hours to about 2.5 hours;
raising the temperature up to about 1430 Celsius degrees to about 1470 Celsius degrees within about 30 minutes to about 60 minutes, and then holding for about 1 hour to about 2 hours;
dropping the temperature to about 900 Celsius degrees within about 120 minutes to about 180 minutes; and
naturally dropping the temperature to room temperature.

16. The method of claim 15, wherein the sintering step comprises:
heating the preformed part obtained in the molding step from room temperature up to a temperature of about 600 Celsius degrees within about 400 minutes, and then holding for about 2 hours;
raising the temperature up to about 1150 Celsius degrees within about 300 minutes, and then holding for about 2 hours;
raising the temperature up to about 1300 Celsius degrees within about 150 minutes, and then holding for about 2 hours;
raising the temperature up to about 1450 Celsius degrees within about 50 minutes, and then holding for about 1.5 hours;
dropping the temperature to about 900 Celsius degrees within about 150 minutes; and
naturally dropping the temperature to room temperature.

17. A Zr-based composite ceramic material prepared by a method of claim 7.

18. A shell or a decoration, made of a Zr-based composite ceramic material of claim 1.
